(19) United States
(12) Patent Application Publication
(10) Pub. No.: US 2012/0153909 A1
(43) Pub. Date: Jun. 21, 2012

(54) HYBRID FAST-SLOW PASSGATE CONTROL METHODS FOR VOLTAGE REGULATORS EMPLOYING HIGH SPEED COMPARATORS

(75) Inventors: William L. Bucossi, Bozeman, MT (US); John F. Bulzacchelli, Yonkers, NY (US); Mohak Chhabra, Morrisville, NC (US); Zeynep Toprak-Deniz, Norwalk, CT (US); Daniel J. Friedman, Sleepy Hollow, NY (US); Joseph A. Iadanza, Hinesburg, VT (US); Todd M. Rasmus, Cary, NC (US)

(73) Assignee: International Business Machines Corporation, Armonk, NY (US)

(21) Appl. No.: 13/213,368

(22) Filed: Aug. 19, 2011

Related U.S. Application Data
(60) Provisional application No. 61/423,923, filed on Dec. 16, 2010.

(51) Int. Cl. G05F 1/10

(52) U.S. Cl. 323/271

(57) ABSTRACT

Voltage regulator circuits and methods implementing hybrid fast-slow passgate control circuitry are provided to minimize the ripple amplitude of a regulated voltage output. In one aspect, a voltage regulator circuit includes a comparator, a first passgate device, a second passgate device, and a bandwidth limiting control circuit. The comparator compares a reference voltage to a regulated voltage at an output node of the voltage regulator circuit and generates a first control signal on a first gate control path based on a result of the comparing. The first and second passgate devices are connected to the output node of the regulator circuit. The first passgate device is controlled in a bang-bang mode of operation by the first control signal to supply current to the output node. The bandwidth limiting control circuit has an input connected to the first gate control path and an output connected to the second passgate device. The bandwidth limiting control circuit generates a second control signal based on the first control signal, wherein the second control signal is a slew rate limited version of the first control signal, and wherein the second passgate is controlled by the second control signal to supply current to the output node.

### CROSS-REFERENCE TO RELATED APPLICATION

This application claims priority to U.S. Provisional Application Ser. No. 61/423,923, filed on Dec. 16, 2010, which is fully incorporated herein by reference.

### TECHNICAL FIELD OF THE INVENTION

The present invention relates generally to voltage regulator circuits and methods and more specifically, high-speed voltage regulator circuits and methods for implementing hybrid fast-slow passgate control circuitry to minimize ripple amplitude of a regulated voltage output.

### BACKGROUND

In general, a voltage regulator is a circuit that is designed to maintain a constant output voltage level as operating conditions change over time. Electronic circuits are designed to operate with a constant DC supply voltage. A voltage regulator circuit provides a constant DC output voltage and contains circuitry that continuously holds the output voltage at the desired value regardless of changes in load current or input voltage (assuming that the load current and input voltage are within the specified operating range for the regulator). Maintaining accurate voltage regulation is particularly challenging when the load current variations are sudden and extreme, e.g. minimum load to maximum load demand in less than couple hundred ps. Such sudden and extreme variations in load current can occur in applications in which the circuitry being powered by the regulator is primarily CMOS logic. Since the majority of the current drawn by CMOS logic is dynamic (current that is used to charge and discharge parasitic capacitances) and not static (such as DC leakage currents), the load current presented to the regulator can change from a minimum to a maximum very quickly when the CMOS logic switches from an idle state to a state with high activity factor (maximum workload).

One type of voltage regulator which has very fast transient response characteristics is referred to as a “bang-bang” type voltage regulator, in which a high speed comparator is utilized to switch a series passgate element from fully on to fully off (and vice versa). The fast response time makes bang-bang type voltage regulators more suitable than their linear counterparts to handle highly varying load current demands with minimal effect on regulated voltage and with the capability of providing near instantaneous response to any variation in load current demand. The fast response time also improves the high-frequency power-supply rejection ratio (PSRR).

However, the use of bang-bang regulators poses design challenges with regard to the ability to achieve suitable DC accuracy on the regulated voltage (due to offsets of the high-speed comparator) and limit the intrinsically generated ripple on the regulated output that results from the sudden switching of the passgate current (bang-bang operation). Another problem arises when a distributed regulator system is formed by connecting the outputs of multiple bang-bang regulators to a common supply grid, as even small mismatches in comparator offsets may result in highly unequal sharing of the load current.

### SUMMARY

Exemplary embodiments of the invention generally include voltage regulator circuits and methods and more specifically, high-speed voltage regulator circuits and methods for implementing hybrid fast-slow passgate control circuitry to minimize the ripple amplitude of a regulated voltage output. In one embodiment, a voltage regulator circuit includes a comparator, a first passgate device, a second passgate device, and a bandwidth limiting control circuit. The comparator compares a reference voltage to a regulated voltage at an output node of the voltage regulator circuit and generates a first control signal on a first gate control path based on a result of the comparing. The first and second passgate devices are connected to the output node of the regulator circuit. The first passgate device is controlled in a bang-bang mode of operation by the first control signal to supply current to the output node. The bandwidth limiting control circuit has an input connected to the first gate control path and an output connected to the second passgate device. The bandwidth limiting control circuit generates a second control signal based on the first control signal, wherein the second control signal is a slew rate limited version of the first control signal, and wherein the second passgate is controlled by the second control signal to supply current to the output node.

In general, the voltage regulator circuit provides a hybrid fast-slow passgate architecture in which the first passgate device (or “fast” passgate) is controlled in a bang-bang manner by the first control signal to handle dynamic load current variations. The first control signal is a gate control signal that transitions rail to rail and causes the first passgate device to switch fully on and off in a bang-bang manner to provide near instantaneous, high speed response. On the other hand, the second passgate device (or “slow” passgate) is not controlled in a bang-bang manner, but rather, the second passgate device is controlled by the second control signal (a slew rate limited version of the first control signal) which does not transition rail to rail so that the second passgate device does not fully switch on and off and operates to supply static or low-frequency components of the load current. Since the second passgate device is not fully switched on and off, the output current supplied by the second passgate device contributes very little to the voltage ripple of the regulated voltage at the output node of the regulator circuit. In this manner, while generation of intrinsic ripple is dominated by the switching of the first (fast) passgate device, the ripple amplitude of the regulated voltage can be significantly reduced by minimally sizing the first (fast) passgate device to provide a current capability to handle just the dynamic portion of the load current and sizing the second (slow) passgate device to provide a current capability to handle the low-frequency components of the load current.

In one exemplary embodiment, the bandwidth limiting control circuit includes an inverter and low pass RC filter network. An input of the inverter is connected to the first gate control path and receives as input an inverted first control signal from the first gate control path and outputs a version of the first control signal to the RC filter network. The RC filter network filters this version of the first control signal to generate the second control signal. In one embodiment, a capacitor of the RC filter network is implemented by a parasitic capacitance of the second passgate device.

In another exemplary embodiment, the bandwidth limiting control circuit includes a current starved inverter circuit.

These and other exemplary embodiments, features, aspects and advantages of the present invention will become apparent from the following detailed description of exemplary embodiments thereof, which is to be read in connection with the accompanying drawings.

### BRIEF DESCRIPTION OF THE DRAWINGS

FIG. 1 is a schematic diagram of an exemplary voltage regulator in which techniques may be implemented for reducing ripple amplitude of a regulated voltage output according to exemplary embodiments of the invention.

FIGS. 2A and 2B are waveform diagrams illustrating a relationship between voltage regulator oscillation frequency and ripple amplitude of the regulated voltage output.

FIG. 3 is a schematic diagram of a voltage regulator circuit according to an exemplary embodiment of the invention.

FIGS. 4A, 4B, and 4C are exemplary waveform diagrams illustrating a mode of operation of the voltage regulator of FIG. 3 according to an exemplary embodiment of the invention.

FIG. 5 is a schematic diagram of a voltage regulator circuit according to another exemplary embodiment of the invention.

FIG. 6 is a schematic diagram of an integrated circuit chip having a distributed voltage regulator system according to an exemplary embodiment of the invention.

FIG. 7 is a schematic diagram of an integrated circuit chip having a distributed voltage regulator system according to another exemplary embodiment of the invention.

FIG. 8 is a schematic diagram of a distributed voltage regulator system having a master/slave framework according to an exemplary embodiment of the invention.

### DETAILED DESCRIPTION OF EXEMPLARY EMBODIMENTS

FIG. 1 is a schematic diagram of an exemplary voltage regulator in which techniques may be implemented for reducing ripple amplitude of a regulated voltage output according to exemplary embodiments of the invention. FIG. 1 is a high-level block diagram of a voltage regulator circuit 100 which generally comprises a comparator circuit 110, gate driver circuitry 120, a passgate device P1, and an output capacitor 130. The voltage regulator circuit 100 operates in a “bang-bang” manner to maintain a regulated voltage Vreg at a regulated voltage output node Nout of the regulator circuit 100.

The comparator 110 has a non-inverting input terminal “+” and an inverting input terminal “−”. A reference voltage Vref is input to the non-inverting input terminal of the comparator 110, and the inverting input terminal “−” is connected to the regulated voltage output node Nout. The reference voltage Vref may be generated using one of various techniques known to those of ordinary skill in the art. For instance, the reference voltage Vref may be a static voltage that is a locally generated reference voltage or a global reference voltage. In other embodiments, the reference voltage may be dynamically generated using methods disclosed in U.S. patent application Ser. No.______ (Attorney Docket YOR920100552US2) entitled “Dual Loop Voltage Regulator Architecture with High DC Accuracy and Fast Response Time”, filed concurrently herewith, and fully incorporated by reference herein. This disclosure introduces a charge pump-based circuit solution that may be implemented to tune the reference voltage Vref which is input to the high-speed comparator 110 to automatically compensate for any DC offset of the high-speed comparator 110.

The passgate device P1 may be a P-type FET (field effect transistor) having a gate terminal G, source terminal S and drain terminal D. The gate terminal G of the passgate P1 is coupled to the output of the comparator 110 via gate driver circuitry 120. The source terminal S of the passgate P1 is coupled to a supply voltage Vin and the drain terminal D of the passgate P1 is coupled to the output node Nout. The capacitor 130 is coupled between the output node Nout and ground.

In general, the gate driver circuitry 120 comprises a plurality of stages S1, S2 . . . Sn along a gate control path of the voltage regulator between the output of the comparator 110 and the gate terminal G of the passgate device P1. Depending on the architecture of the voltage regulator 100, the various stages may include linear amplifiers, level shifters, and inverters for generating a gate control signal GC to drive the gate terminal of the passgate P1. In the exemplary embodiment of FIG. 1, the last stage Sn of the gate driver circuitry 120 may be an inverter that operates rail-to-rail (from Vin to ground voltage levels) to output the gate control signal GC.

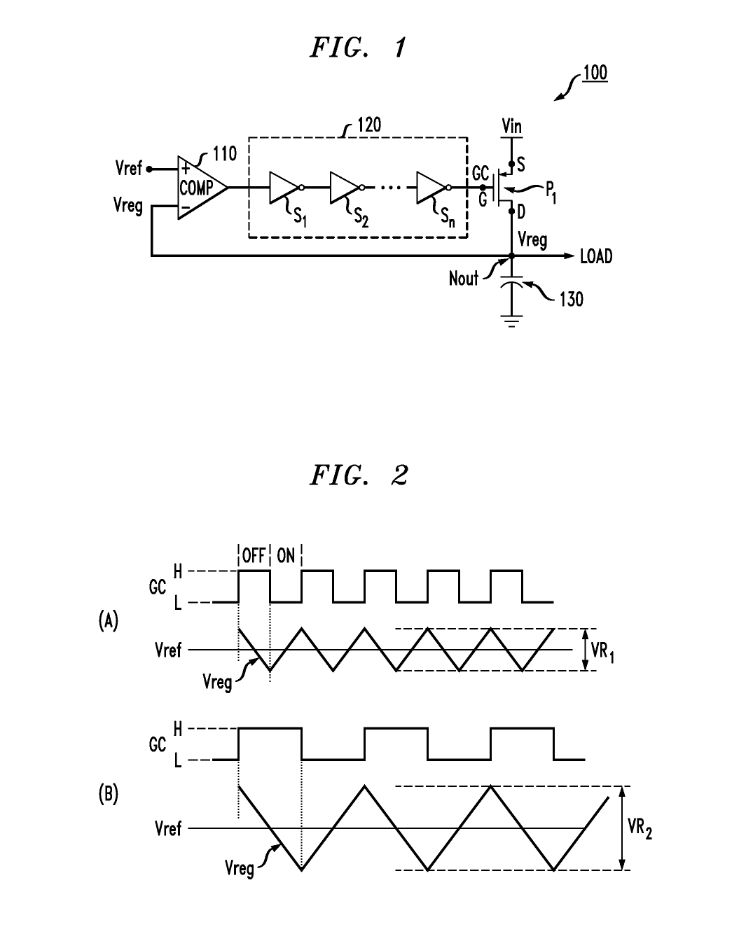

In general, the voltage regulator 100 of FIG. 1 operates in a bang-bang manner by generating a limit-cycle oscillation as follows. The high-speed voltage comparator 110 compares the regulated voltage Vreg with respect to the reference level Vref. FIG. 2A depicts exemplary waveform diagrams of a gate control signal GC, reference voltage Vref and a regulated voltage Vreg that can be generated by operation of the voltage regulator circuit 100. With reference to FIG. 2A, when the regulated voltage Vreg falls below Vref, the high-speed comparator 110 will output a logic “one” and the passgate control signal GC will transition to a logic “zero” level after a propagation delay (Tprop) of the critical gate control path. The passgate P1 will turn on and start to charge the capacitor 130 connected to the regulated voltage output node Nout (working against the load current), and hence the regulated voltage Vreg will increase. When the regulated voltage Vreg rises above the reference threshold Vref, the output of the comparator 110 will become logic “zero”, and the gate control signal GC will transition to a logic “high” level after another Tprop delay along the critical path, turning off the passgate P1. While the passgate P1 is turned off, the load current will discharge the regulated output voltage Vreg at some rate. When the regulated voltage Vreg falls below Vref, the entire cycle repeats. In this way, regulation is achieved by continuous oscillation of the passgate control signal GC.

In the exemplary waveform diagram of FIG. 2A, the duty cycle of the gate control signal GC is depicted as 50%. However, a general operating principle of the bang-bang control is that the duty cycle (on/off time of passgate P1) is adjusted so that on average the drain current of the passgate P1 is equal to the load current. As an example, if the load current is 30 mA, and the ON current of the passgate P1 is 50 mA, then the bang-bang voltage regulator duty cycle will be 60% after the regulator reaches equilibrium.

In order to minimize over/under shoot (ripple amplitude) of the regulated voltage Vreg, various design factors are considered. For example, to reduce the ripple of Vreg, the response time of the bang-bang regulator circuit should be minimized. In other words, the propagation delay (Tprop) of the critical path controlling the passgate P1 should be minimized. FIGS. 2A and 2B illustrate a relationship between bang-bang regulator oscillation frequency of the gate control signal GC and ripple amplitude of Vreg. In the exemplary embodiments of FIGS. 2A and 2B, the oscillation frequency of the passgate control signal GC in FIG. 2B is smaller than the oscillation frequency of the passgate control signal GC in FIG. 2A (where it is assumed that the duty cycle of GC in FIGS. 2A and 2B is 50%). The lower oscillation frequency of GC directly translates to higher voltage ripple (VR) of Vreg, where VR2 in FIG. 2B is depicted as being greater than VR1 in FIG. 2A, which is not desirable. Assuming the duty cycle is close to 50%, and assuming an ideal capacitor without a series resistance, the theoretical period of the ripple of Vreg is approximately equal to four times the propagation delay Tprop of the bang-bang regulator. In practice, where a capacitor having an equivalent series resistance (ESR) is used, the delay may be close to two times the propagation delay.

Another design factor that is considered in reducing the voltage ripple of Vreg in the bang-bang regulator 100 of FIG. 1 is the size of the passgate P1. In general, the passgate P1 should be sized so that its drain current (when ON) exceeds the total load current at all times. Otherwise, high load currents that exceed the current output of the passgate P1 will cause the regulator to enter a dropout condition and diminish the voltage accuracy. This design requirement can lead to significant over sizing of the passgate P1 in applications where the static load current (due to leakage, base activity, and/or constant current circuits such as CML logic) is of comparable magnitude to the dynamic load current. The passgate P1 is “oversized” in the sense that the AC current generated by switching the passgate P1 on and off (via the rail-to-rail GC signal) may be significantly larger than the dynamic component of the load current. This over sizing of the passgate P1 results in increased intrinsic ripple amplitude of Vreg, which is undesirable for the voltage regulator.

One approach to reduce ripple amplitude of Vreg is to limit the modulation of the on current of the passgate P1 with a slew rate limited gate control method. As an illustrative example, a current-starved inverter may be used, for example, in place of the last inverter stage Sn to limit the slew rate of the GC signal at the gate node G of the passgate P1. However, this solution may not be ideal in that it slows down the response of the critical path of the bang-bang regulator 100. This not only reduces the ripple frequency, but also degrades the ability of the regulator 100 to respond to a rapid change in load current which is a benefit of the bang-bang regulator operation. Another drawback of this approach is that the lower ripple frequency would make it more difficult to filter the noise on the regulated supply voltage with on-chip components.

What is desired, therefore, is a regulator which combines the benefits of high-speed bang-bang operation and slew-rate-limited output devices. Such benefits include (i) minimum critical path delay for fast response time and good high-frequency PSRR (ii) high ripple frequency and (iii) reduced ripple amplitude.

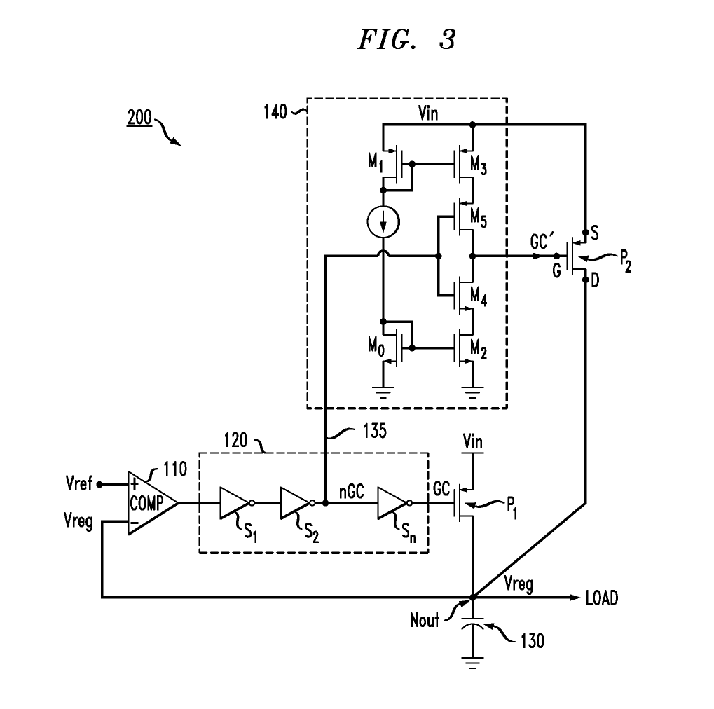

FIG. 3 is a schematic diagram of a voltage regulator circuit implementing bandwidth limiting gate control circuitry to minimize ripple amplitude of a regulated voltage output, according to an exemplary embodiment of the invention. In particular, FIG. 3 illustrates a voltage regulator circuit 200 which, similar to the voltage regulator of FIG. 1, comprises comparator circuit 110, gate driver circuitry 120, passgate device P1, and output capacitor 130 to provide bang-bang operation via the critical gate control path controlling the passgate P1. The voltage regulator circuit 200 comprises a second gate control path 135 having a bandwidth limiting gate control circuit 140 that drives a second passgate device P2. The passgate P2 may be a P-type FET (field effect transistor) having a gate terminal G, source terminal S and drain terminal D. The gate terminal G of the passgate P2 is coupled to the output of the bandwidth limiting gate control circuit 140. The source terminal S of the passgate P2 is coupled to the supply voltage Vin and the drain terminal D of the passgate P2 is coupled to the regulated output node Nout.

In general, the voltage regulator 200 of FIG. 2 provides a hybrid fast-slow passgate architecture in which passgates P1 and P2 are connected in parallel to the regulated voltage node Nout and controlled by respective gate control signals GC and GC′. The input of the bandwidth limiting gate control circuit 140 is tapped from the gate control path that drives the passgate P1. More specifically, the input to the bandwidth limiting gate control circuit 140 in the second control path 135 is connected to the first gate control path at the input to the last rail-to-rail inverter stage Sn. In this regard, both the inverter Sn and the input bandwidth limiting gate control circuit 140 receive as input the same complementary signal nGC. While inverter stage Sn outputs the gate control signal GC, the bandwidth limiting gate control circuit 140 generates gate control signal GC′ to drive passgate P2, wherein gate control signal GC′ is a slew rate limited version of the gate control signal GC that drives passgate P1 .

In general, the voltage regulator 200 of FIG. 2 provides a hybrid fast-slow passgate architecture in which passgate P1 (“fast” passgate) is controlled in a bang-bang manner to handle dynamic load current variations. The gate control signal GC transitions rail to rail and causes the passgate P1 to switch fully on and off (such as discussed above with reference to FIG. 2) to provide bang-bang response. On the other hand, the passgate P2 (“slow” passgate) is controlled with a slew rate limited gate control signal GC′ so that the passgate P2 is not fully switched on and off and operates to supply static or low-frequency components of the load current. Since the second passgate P2 is not fully switched on and off, the output current supplied by passgate P2 contributes very little to the voltage ripple of Vreg. As explained in further detail below, while generation of intrinsic ripple is dominated by the switching of the fast passgate P1, the ripple amplitude can be significantly reduced by reducing the size (current capability) of the fast passgate P1 to handle just the dynamic portion of the load current and sizing the slow passgate P2 to provide a current capability to handle the low-frequency components of the load current.

In the exemplary embodiment, the bandwidth limiting gate control circuit 140 comprises a current starved inverter circuit comprising transistors M0, M1, M2, M3, M4, and M5, having a conventional topology. Transistor pairs M1/M3 and M0/M2 are current mirrors, and transistors M4 and M5 form an inverter having gate terminals that are commonly connected as the input to the circuit 140. The current mirrors M1/M3 and M0/M2 control and limit the current that flows to the inverter transistors M4 and M5 so that the complementary (rail to rail) gate control signal nGC is effectively low pass filtered to output a slew rate limited gate control voltage GC′ which does not transition rail to rail as GC, so that operation of the slow passgate P2 minimizes additional ripple of Vreg caused by passgate P2.

A few different operating regimes of the passgate P2 are possible, depending on the duty cycle of the high-speed gate control path that controls passgate P1. For example, when the regulator 200 operates with a low duty cycle (e.g., duty cycle<40%, corresponding to low load current demand) where the gate control signal GC of the fast passgate P1 is logic high most of the time, gate control signal GC′ of the slow passgate P2 will be substantially pinned to a high level, such that the passgate P2 is turned off, which results in no current conduction through the passgate P2. When the regulator 200 operates with a high duty cycle (e.g., duty cycle>60%, corresponding to high load current demand) where the gate control signal GC of the fast passgate P1 is logic low most of the time, the gate control signal GC′ of the slow passgate P2 will be pinned close to ground, such that the passgate P2 is fully turned on, thus providing maximum additional output current to the regulated node Nout. When the duty cycle of the regulator 200 is in an intermediate range (e.g., duty cycle between 40% to 60%), the gate control signal GC′ of the passgate P2 will be at a middle voltage level resembling an analog control voltage for the passgate P2.

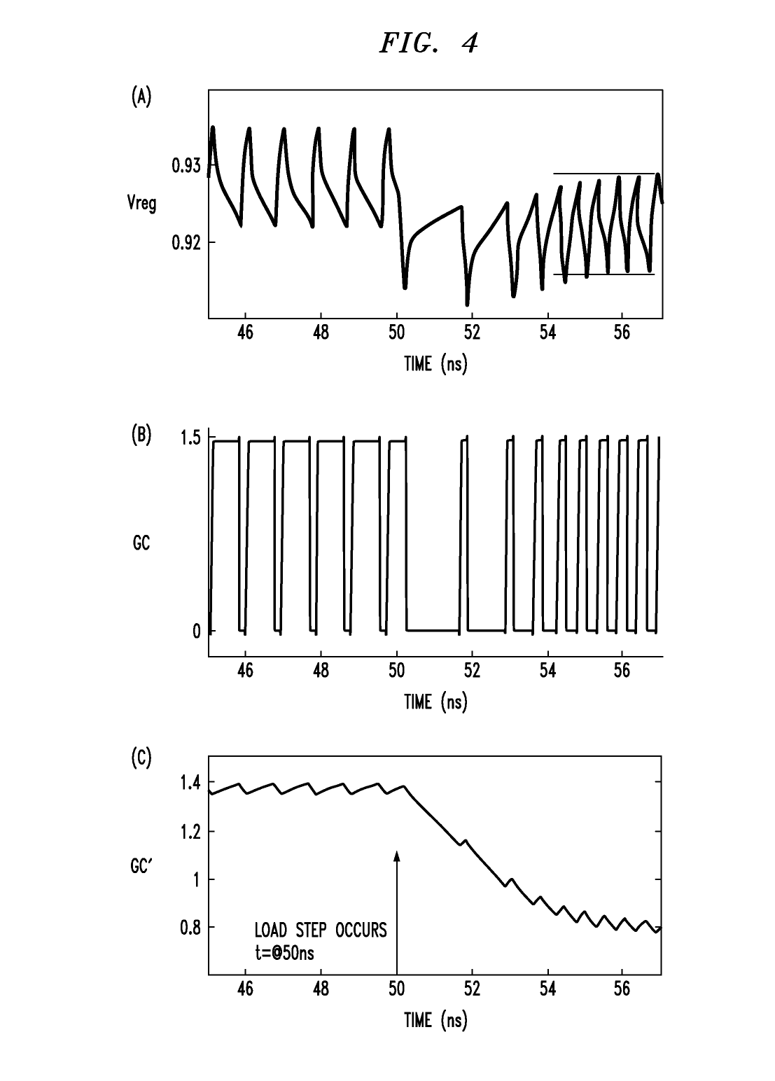

FIGS. 4A, 4B, and 4C are exemplary simulated waveform diagrams illustrating a mode of operation of the voltage regulator of FIG. 3 according to an exemplary embodiment of the invention. FIG. 4A is an exemplary waveform of a regulated voltage Vreg, FIG. 4B is an exemplary waveform of a gate control signal GC input to passgate P1 and FIG. 4C is an exemplary waveform of a gate control signal GC′ input to passgate P2. In the exemplary waveform diagrams, it is assumed that Vreg is 0.925 volts and Vin is 1.5 volts and ground is 0 volts. As shown in FIG. 4B, the gate control signal GC is a digital signal that switches rail to rail (1.5-0 volts) to rapidly switch passgate P1 on and off.

As depicted in the exemplary waveform diagrams, at a time period less than 50 ns, it is assumed that the regulator 200 is operating with a low duty cycle under low load current conditions. In particular, as indicated by the GC waveform of FIG. 4B, the gate control signal GC has a low duty cycle (e.g., lower than 40%) and is at a logic high level for most of the time such that passgate P1 is turned off most of the time. Under low load current conditions, the fast passgate P1 is turned on for short periods of time to provide sufficient current to handle the low load current and maintain the regulated output voltage level Vreg. On the other hand, as shown in FIG. 4C, under low load conditions where the duty cycle of GC is low, the gate control voltage GC′ of the slow passgate P2 is effectively maintained at a high DC level so that the slow passgate P2 is off and does not output current to the regulated voltage output node Nout.

At time t=50 ns, a high load current step is shown to occur, where the duty cycle of the regulator increases significantly such that the duty cycle of the gate control signal GC (as shown in FIG. 4B) significantly increases for a few cycles (e.g., above 60%) where the gate control voltage GC is logic “low” most of the time. In this circumstance, the fast passgate P1 is turned on for most of the time to output sufficient current to the regulated voltage output node Nout. Furthermore, under high load current demand and increased duty cycle of GC, the gate control voltage GC′ of the slow passgate P2 starts to decrease to a level that causes the passgate P2 to begin turning on and supply additional current to the regulated output node Nout. As shown in FIG. 4C, gate control signal GC′ is effectively maintained at an intermediate DC level (between 0 and 1.5) so that the slow passgate P2 is also turned on to output current (in a DC manner) to the regulated voltage output node Nout. The gate control voltage GC′ of the slow passgate P2 is effectively an analog voltage that is adjusted to some level between the input supply level Vin and the ground voltage level depending on the duty cycle of the gate control voltage GC of the fast passgate P1.

As shown in FIG. 4C, the ripple of the gate control voltage GC′ that is applied to the slow passgate P2 is very small as compared to the rail-to-rail swing of the gate control voltage GC applied to the fast passgate P1. In this regard, the gate control voltage GC′ is essentially a low pass filtered version of the gate control signal GC. Therefore, the slow passgate P2 essentially supplies a DC current to the regulated voltage node Nout to increase the current capability of the regulator under high load conditions, but not increasing the ripple amplitude of the Vreg voltage. The ripple amplitude is defined primarily by the strength (width) of the fast passgate P1. When the fast passgate P1 is turned “on”, a current pulse is applied to the capacitor 130 which causes the voltage Vreg to ramp up. Since the fast passgate P1 can be made smaller (lower current capability) to handle just the dynamic (switching) load current needs, assuming the response time (propagation delay) along critical path remains the same, then reduced ripple amplitude can be realized under all load conditions. Since the slow passgate P2 does not contribute significantly to the voltage ripple, there is no increase in ripple amplitude on the output node Nout when the slow passgate P2 is on as shown in FIG. 4C. A reduction in the voltage ripple is realized by virtue of the fast passgate P1 being made smaller for handling only the dynamic portion of the load current, as compared to conventional schemes (such as described with reference to FIG. 1) where the passgate P1 would have to be made larger in size to be capable of supplying all the load current.

In this regard, the negative feedback provided by the fast and slow gate control loops ensures that the combination of passgates P1 and P2 provides the necessary amount of current to the regulated node Nout. The fast passgate P1 can be sized such that it can handle the worst case dynamic load current step by changing its duty cycle almost instantaneously (to a value anywhere from 0 to 100%), while adding no extra delay to the critical gate control path between the high-speed comparator 110 and the passgate P1. Consequently, the high ripple frequency, fast response time, and high frequency PSRR of a pure bang-bang regulator (such as the one shown in FIG. 1) are preserved. As previously illustrated in FIG. 2, the high ripple frequency also has benefits in reducing ripple amplitude.

In the voltage regulator 100 of FIG. 1, the size of the passgate device P1 would depend on the anticipated load and the VDS headroom. As the anticipated load current increases and the VDS headroom lowers, the size of the passgate must be increased to provide sufficient current. In the exemplary voltage regulator 200 of FIG. 3, the passgates P1 and P2 are sized such that their combined sizes would provide the appropriate load current when both passgates were turned on. The appropriate current capacity would be the maximum load current for the given Vreg, and the passgate would have to be sized for this current capacity at the anticipated minimum VDS setting. The maximum load current would be a function of the AC switching current and low frequency currents such as leakage current and DC bias currents.

The total passgate size (channel width) would then be divided between the two passgates P1 and P2. A portion of the total size would be apportioned to the fast passgate P1 so that the passgate P1 could handle the maximum AC or transition current level, and the slow passgate P2 would be apportioned the remainder of the total size. By reducing the size of the fast passgate P1 (which fully turns on and off during operation), the current modulation that charges the capacitor 130 is reduced and, thus, the ripple amplitude of Vreg is reduced. However, the regulator circuit 200 can supply the necessary current under maximum load conditions because the gate voltage of the slow passgate P2 is adjusted accordingly with the closed loop control to turn on the slow passgate P2 and provide the extra necessary load current without adding to the ripple amplitude.

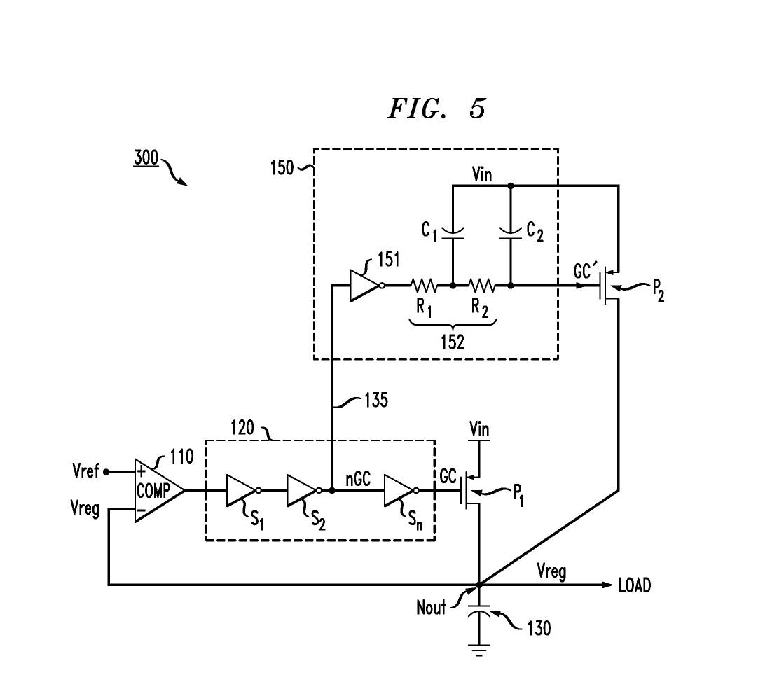

FIG. 5 is a schematic diagram of a voltage regulator circuit implementing bandwidth limiting gate control circuitry to minimize ripple amplitude of a regulated voltage output, according to another exemplary embodiment of the invention. In particular, FIG. 5 illustrates a voltage regulator circuit 300 which is similar to the voltage regulator 200 of FIG. 3, but drives the second passgate P2 using a bandwidth limiting gate control circuit 150 that comprises an inverter 151 and an nth order RC low pass filter 152. In general, the order of the low pass filter 152 can be from 1^{st} to nth order depending on the circuit optimization constraints. FIG. 5 illustrates a second order low pass filter comprising resistors R1 and R2 serially connected between the output of the inverter 151 and the gate of passgate P2, and capacitors C1 and C2 connected between the Vin node and resistors as shown.

In the exemplary embodiment of FIG. 5, the input of the bandwidth limiting gate control circuit 150 is tapped from the gate control path that drives the passgate P1. More specifically, the input to the inverter 151 is connected to the first gate control path at the input to the last rail-to-rail inverter stage Sn. In this regard, the inverter Sn and the inverter 151 receive the same complementary signal nGC as input. In an exemplary embodiment, the inverter 151 is a rail-to-rail inverter that operates similarly to inverter Sn such that inverter Sn outputs the gate control signal GC and the inverter 151 outputs a control signal that is substantially the same, or a version of, the gate control signal GC. In particular, although both inverters 151 and Sn receive the same input signal nGC, the output signal of the inverter 151 will not be exactly the same as the signal GC output from the inverter Sn—rather the output of the inverter 151 will be a similar version of the output signal GC of the inverter Sn because the loading at the output of the inverters 151 and Sn is different (i.e., the inverter 151 drives the RC network 152, while Sn drives the fast pass gate P1).

While the fast passgate P1 is directly controlled by the gate control signal GC in the first gate control path to provide bang-bang operation as discussed above, the output from the inverter 151 of the bandwidth limiting gate control circuit 150 is low pass filtered by RC filter 152 to generate a slew rate limited control signal GC′ in the second gate control path 135 so that the gate voltage of slow passgate P2 does not switch rail to rail, again minimizing the additional ripple introduced by the passgate P2 as discussed above.

In the exemplary embodiment of FIG. 5, the values of resistors R1 and R2 and capacitors C1 and C2 would be selected to achieve a desired slew rate for the given application and voltage levels Vin and Vreg, etc. The capacitor C2 may be implemented using an actual capacitor element or the capacitor C2 may be implemented using a parasitic gate capacitance of the passgate P2.

In the exemplary embodiment of FIG. 5, since the RC filter 152 is a linear network, the voltage of control signal GC′ input to the passgate P2 is a linear function of the duty cycle of the control signal GC in the critical gate control path driving the fast passgate P1. This linear relationship is contrasted to the nonlinear relationship obtained using the current-starved inverter topology of FIG. 3, which provides distinct operating regimes of low, intermediate, and high duty cycles as discussed above. In other words, with the embodiment of FIG. 5, the gate voltage of the slow passgate P2 will not be pinned to high/low supply rails for a range of low/high duty cycles respectively, as with the current starved inverter embodiment of FIG. 3, but it will represent an analog voltage level corresponding to the duty cycle of GC. As a result, the slow passgate P2 will source a substantially DC current.

In another exemplar embodiment of FIG. 5, the input of the bandwidth limiting gate control circuit 150 may be tapped from another point in the gate control path that drives the passgate P1, rather than at the input of the inverter stage Sn as depicted in FIG. 5. For instance, the input to the bandwidth limiting gate control circuit 150 may be tapped at an input to another inverter stage (in the gate control path) having an output connected to the input of the last inverter stage Sn. In this regard, an input signal to the bandwidth limiting gate control circuit 150 would be a similar version of GC (not nGC), and the inverter 151 would be replaced with a non-inverting buffer. In this exemplary embodiment, the non-inverting buffer would output a control signal that is substantially the same, or a similar version of, the gate control signal GC.

In yet another exemplary embodiment of FIG. 5, the input to the bandwidth limiting gate control circuit 150 may be tapped at the output of the last inverter stage Sn, in which case the inverting buffer 151 would not be included, and the inverter stage Sn would directly drive the RC filter 152. In particular, the output of the last inverter stage Sn would be directly connected to R1 and the signal GC output from the last inverter stage Sn would be low pass filtered by the RC filter 152 to generate a slew rate limited control signal GC′ in the second gate control path 135.

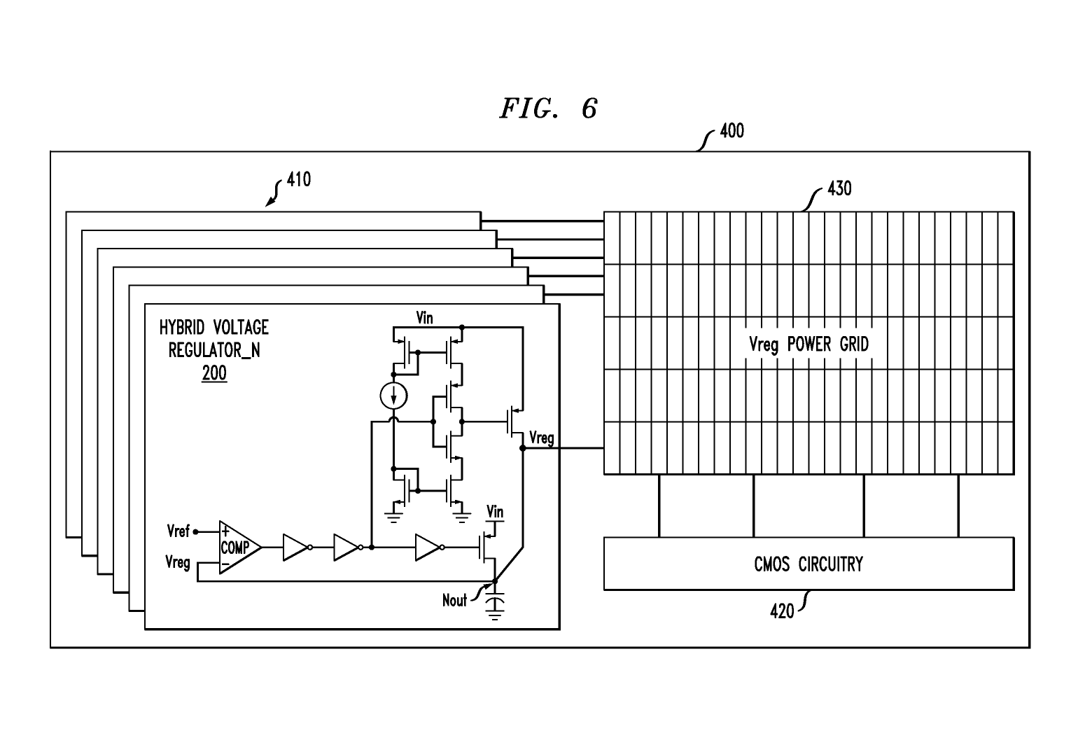

In other exemplary embodiments of the invention, the voltage regulator circuits of FIGS. 3 and 5 may be implemented in distributed voltage regulator systems. For example, FIG. 6 is a schematic diagram of an integrated circuit chip having a distributed voltage regulator system according to an exemplary embodiment of the invention. In particular, FIG. 6 depicts an integrated circuit chip 400 comprising a plurality of voltage regulator circuits 410 with regulated voltage output nodes Nout connected to logic circuitry 420 via Vreg power grid 430. In the exemplary embodiment of FIG. 6, each of the voltage regulator circuits 410 may be implemented using the voltage regulator 200 framework of FIG. 3. The voltage regulator circuits 410 are disposed in various regions of the chip such that the regulated voltage outputs Vreg of the regulators 410 are connected at different points of the power grid 430 to provide the desired Vreg to logic circuitry 420 connected to the grid 430. The power grid may be formed by one or more metallization layers formed over an active surface of the chip 400 in which the circuitry is formed.

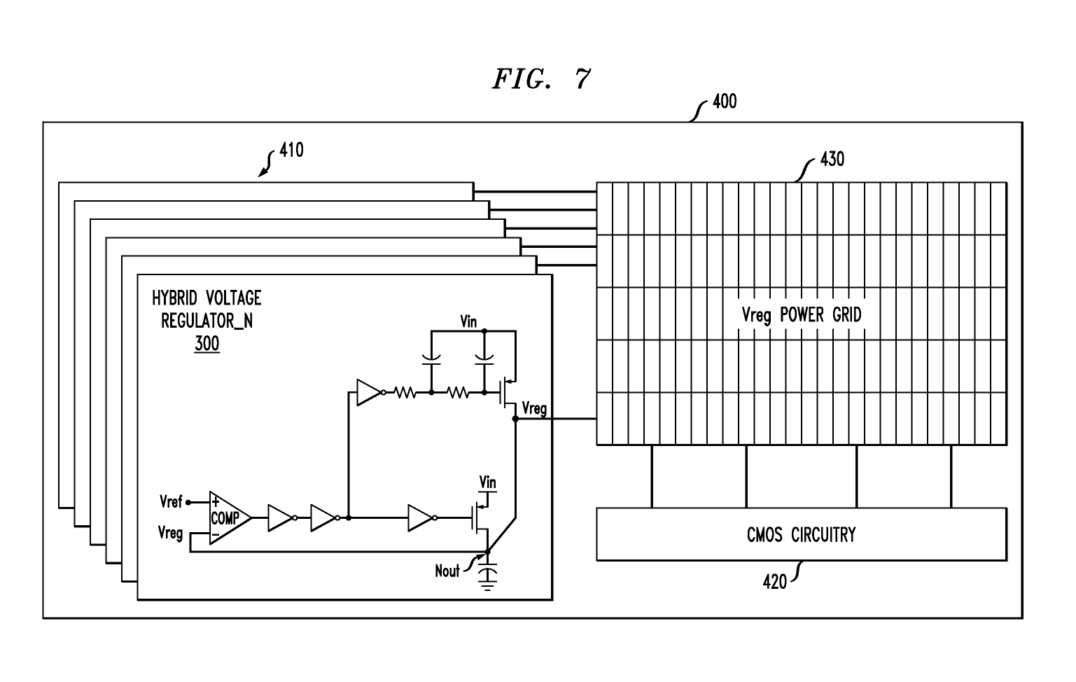

FIG. 7 is a schematic diagram of an integrated circuit chip having a distributed voltage regulator system according to another exemplary embodiment of the invention. FIG. 7 schematically illustrates an integrated circuit chip 400 similar to that of FIG. 6, having a plurality of voltage regulator circuits 410 with regulated voltage output nodes Nout connected to logic circuitry 420 via Vreg power grid 430. However, the plurality of voltage regulator circuits 410 of FIG. 7 are implemented using the voltage regulator 300 framework of FIG. 5.

In the exemplary embodiment of FIG. 6 in which the plurality of voltage regulator circuits 410 are implemented with the voltage regulator circuit 200 having a current starved inverter as the bandwidth limiting gate control circuit 140 distributed across the regulated grid 430, load sharing issues may arise due to mismatch of the high-speed comparators 100. More specifically, when there is some mismatch (e.g. threshold mismatch) between high speed comparators of different voltage regulator circuits 200 distributed over the chip, one voltage regulator 200 might oscillate with a 38% duty cycle while another voltage regulator 200 might oscillate with a 62% duty cycle. Because the relationship between the gate control voltage GC′ output from the current-starved inverter implementation and the duty cycle of gate control signal GC is highly nonlinear (as discussed above), even small differences in the duty cycle of GC can result in large differences in the gate voltages GC′ of the slow passgates P2 of different regulator circuits 200 distributed over the grid. For instance, the passgate P2 in the regulator with 38% duty cycle would be turned fully off, while the passgate P2 in the regulator with 62% duty cycle would be turned fully on, resulting in a dramatically imbalanced load sharing among the distributed voltage regulators.

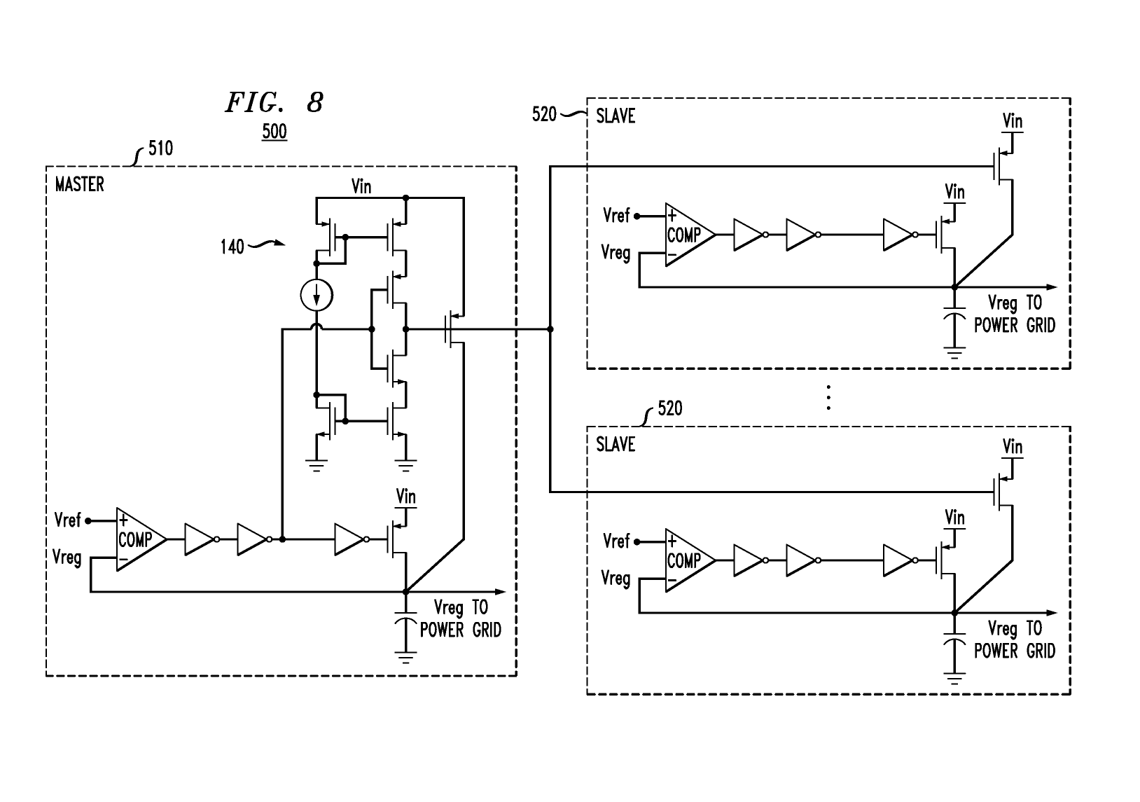

This imbalanced load sharing issue can be addressed using the framework depicted in FIG. 8. FIG. 8 schematically illustrates a distributed regulator system 500 according to an exemplary embodiment of the invention, wherein a plurality of voltage regulator circuits 200 of FIG. 6 are implemented in a master-slave framework. In FIG. 8, a distributed voltage regulator system 500 comprises a master regulator 510 and a plurality of slave regulators 520. The master regulator 510 is implemented using the voltage regulator 200 framework of FIG. 3 having a dedicated bandwidth limiting gate control circuit 140 (current starved inverter) to drive the passgate P2 of the master regulator 510 as well as the passgates P2 of each slave regulator 520. More specifically, in this exemplary embodiment, the slave regulators 520 do not have their own bandwidth limiting gate control circuits 140 (current starved inverter) to drive the respective passgates P2, but rather, each passgate P2 of the slave regulators 520 are connected to and driven by the output of the bandwidth limiting gate control circuit 140 of the master regulator 510. With this approach, load sharing will be limited by the duty cycle matching of the fast passgates P1 of the master and slave regulators 510 and 520, which is affected by mismatch of the high-speed comparators. It is to be appreciated, however, that this limitation due to mismatch of the high-speed comparators can be overcome using the techniques disclosed in the above-referenced application, U.S. patent application Ser. No.______ (Attorney Docket YOR920100552US2) entitled “Dual Loop Voltage Regulator Architecture with High DC Accuracy and Fast Response Time,” wherein better load sharing can be achieved using a charge pump circuit to tune the threshold voltage of the high-speed comparator to compensate for any mismatch, IR drop etc.

On the other hand, in the exemplary embodiment of FIG. 7 wherein the plurality of voltage regulators are implemented using the voltage regulator 300 framework of FIG. 5 where a linear RC filter is used for slew-rate limiting, sufficient load sharing can be maintained without employing a master-slave arrangement such as shown in FIG. 8. In particular, since the gate control voltage GC′ output from the RC filter has a linear relationship to the duty cycle of the gate control signal GC, moderate differences in duty cycle between separate voltage regulators that are distributed over the power grid would not result in large differences in gate control voltages GC′ applied to the slow passgates P2, so load sharing would not be dramatically imbalanced. Hence, acceptable load sharing behavior can be achieved in the distributed system of FIG. 7 using the high-speed voltage regulator circuits 300 of FIG. 5.

An integrated circuit in accordance with the present invention can be employed in any application and/or electronic system. Suitable systems for implementing the invention may include, but are not limited to, personal computers, communication networks, electronic commerce systems, portable communications devices (e.g., cell phones), solid-state media storage devices, etc. Systems incorporating such integrated circuits are considered part of this invention. Given the teachings of the invention provided herein, one of ordinary skill in the art will be able to contemplate other implementations and applications of the techniques of the invention.

Although illustrative embodiments of the invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A voltage regulator circuit, comprising:
a comparator for comparing a reference voltage to a regulated voltage at an output node of the voltage regulator circuit and generating a first control signal on a first gate control path based on a result of the comparing;
a first passgate device connected to the output node, wherein the first passgate device is controlled in a bang-bang mode of operation by the first control signal to supply current to the output node;
a second passgate device connected to the output node; and
a bandwidth limiting control circuit having an input connected to the first gate control path and an output connected to the second passgate device, the bandwidth limiting control circuit generating a second control signal based on the first control signal, wherein the second control signal is a slew rate limited version of the first control signal, and wherein the second passgate is controlled by the second control signal to supply current to the output node.

2. The voltage regulator of claim 1, wherein the bandwidth limiting control circuit comprises a buffer and a low pass RC filter network.

3. The voltage regulator of claim 2, wherein the buffer is an inverter.

4. The voltage regulator circuit of claim 3, wherein an input of the inverter is connected to the first gate control path and receives as input an inverted first control signal from the first gate control path and outputs a similar version of the first control signal to the RC filter network, and wherein the RC filter network filters the similar version of the first control signal to generate the second control signal.

5. The voltage regulator circuit of claim 2, wherein a capacitor of the RC filter network is implemented by a parasitic capacitance of the second passgate device.

6. The voltage regulator circuit of claim 1, wherein the bandwidth limiting control circuit comprises a current starved inverter.

7. An integrated circuit chip, comprising:
a power grid;
a load circuit connected to the power grid; and
a distributed voltage regulator system comprising a plurality of voltage regulator circuits, each voltage regulator circuit generating a regulated voltage at an output node of the voltage regulator circuit, each output node connected to a different point on the power grid to supply a regulated voltage to the load circuit,
wherein each voltage regulator circuit comprises:
a comparator for comparing a reference voltage to the regulated voltage at the output node of the voltage regulator circuit and generating a first control signal on a first gate control path based on a result of the comparing;
a first passgate device connected to the output node, wherein the first passgate device is controlled in a bang-bang mode of operation by the first control signal to supply current to the output node;
a second passgate device connected to the output node; and
a bandwidth limiting control circuit having an input connected to the first gate control path and an output connected to the second passgate device, the bandwidth limiting control circuit generating a second control signal based on the first control signal, wherein the second control signal is a slew rate limited version of the first control signal, and wherein the second passgate is controlled by the second control signal to supply current to the output node.

8. The integrated circuit chip of claim 7, wherein the bandwidth limiting control circuit comprises a buffer and a low pass RC filter network.

9. The integrated circuit chip of claim 8, wherein the buffer is an inverter.

10. The integrated circuit chip of claim 9, wherein an input of the inverter is connected to the first gate control path and receives as input an inverted first control signal from the first gate control path and outputs a similar version of the first control signal to the RC filter network, wherein the RC filter network filters the similar version of the first control signal to generate the second control signal.

11. The integrated circuit chip of claim 8, wherein a capacitor of the RC filter network is implemented by a parasitic capacitance of the second passgate device.

12. The integrated circuit chip of claim 7, wherein the bandwidth limiting control circuit comprises a current starved inverter.

13. An integrated circuit chip, comprising:
a power grid;
a load circuit connected to the power grid; and
a distributed voltage regulator system comprising a plurality of voltage regulator circuits, each voltage regulator circuit generating a regulated voltage at an output node of the voltage regulator circuit, each output node connected to a different point on the power grid to supply the regulated voltage to the load circuit,
wherein the voltage regulator circuits comprise at least one master voltage regulator and one or more slave voltage regulator circuits,
wherein the at least one master voltage regulator comprises:
a comparator for comparing a reference voltage to the regulated voltage at the output node of the voltage regulator circuit and generating a first control signal on a first gate control path based on a result of the comparing;
a first passgate device connected to the output node, wherein the first passgate device is controlled in a bang-bang mode of operation by the first control signal to supply current to the output node;
a second passgate device connected to the output node;
a bandwidth limiting control circuit having an input connected to the first gate control path and an output connected to the second passgate device, the bandwidth limiting control circuit generating a second control signal based on the first control signal, wherein the second control signal is a slew rate limited version of the first control signal, and wherein the second passgate is controlled by the second control signal to supply current to the output node, and
wherein each of the one or more slave voltage regulator circuits comprises:
a comparator for comparing a reference voltage to the regulated voltage at the output node of the voltage regulator circuit and generating a first control signal on a first gate control path based on a result of the comparing;
a first passgate device connected to the output node, wherein the first passgate device is controlled in a bang-bang mode of operation by the first control signal to supply current to the output node;
a second passgate device having an output connected to the output node of the slave voltage regulator and having an input connected to the bandwidth limiting control circuit of the master voltage regulator, wherein the second control signal generated by the bandwidth limiting control circuit of the master voltage regulator drives the second passgate of each slave voltage regulator circuit.

14. The integrated circuit chip of claim 13, wherein the bandwidth limiting control circuit of the at least one master voltage regulator comprises a current starved inverter.

15. A method for regulating voltage, comprising:
controlling a first passgate device in a bang-bang mode of operation using a first control signal generated on a first gate control path, to output current from the first passgate to a regulated voltage node; and
controlling a second passgate device, connected in parallel to the first passgate device, using a second control signal generated on a second gate control path, to output current from the second passgate to the regulated voltage node, wherein the second control signal is a slew rate limited version of the first control signal.

16. The method of claim 15, comprising generating the second control signal by receiving a complementary first control signal from the first gate control path, inverting the complementary signal to output a similar version of the first control signal on the second gate control path and low pass filtering the similar version of the first control signal to generate the second control signal.

17. The method of claim 15, comprising generating the second control signal by receiving a signal from the first gate control path, buffering the signal from the first gate control path to output a similar version of the first control signal on the second gate control path and low pass filtering the similar version of the first control signal to generate the second control signal.

18. The method of claim 15, comprising generating the second control signal by receiving a complementary first control signal from the first gate control path, applying the complementary first control signal to the input of a current starved inverter, and generating the second control signal at the output of the current starved inverter on the second gate control path.
